(19) United States
(12) Patent Application Publication
(10) Pub. No.: US 2006/0184389 A1
(43) Pub. Date: Aug. 17, 2006

(54) Physicians' optimal management of health information

(76) Inventors: Anuthep Benja-Athon, New York, NY (US); Theda Benja-Anthon, Port Washington, NY (US)

Correspondence Address: ANUTHEP BENJA-ATHON;Gr. FLOOR, 210 E 36th St., New York, NY, 10016, US

(21) Appl. No.: 11/150,878

(22) Filed: Jun. 13, 2005

Related U.S. Application Data
(63) Continuation-in-part of application No. 11/114,763, filed on Apr. 27, 2005.
Application No. 11/114,763 is a continuation-in-part of application No. 11/074,236, filed on Mar. 7, 2005.
Application No. 11/114,763 is a continuation-in-part of application No. 11/059,088, filed on Feb. 16, 2005.

(51) Int. Cl. G06Q 10/00

(52) U.S. Cl. 705/2

(57) ABSTRACT

A computerized system comprising computer commands, health and health-care information and fields of distinct health and health-care information identifications adaptable to computer-automatically and continually merge health and health-care information on an individual, individuals or people to modify and expand on health and health-care databases on individual, individuals or people in a network of computers.

This application is a continuation-in-part of application Ser. No. 11/114,763 entitled A System of Influencing Health-Care Utilizations filed Apr. 27, 2005 which is a continuation-in-part of application Ser. No. 11/074,236 entitled the System of Management of Health-Care Resources filed Mar. 7, 2005 and Ser. No. 11/059,088 entitled the Consumers-Buyers-Physicians Health-Care filed Feb. 16, 2005 which are pending.

### FIELD OF INVENTION

Computerized system of creation and management of electronic health information.

### BACKGROUND OF THE INVENTION

This patent application and eight other patent pendings including said application Ser. No. 11/114,763—details cited in Ser. No. 11/114,763—and one patent U.S. Pat. No. 6,132,218 granted to this physician applicant represent the applicants' continual quests to provide the optimal solution to the current health-care crisis. Said inventions are the only means for solving current American health-care crisis and improve the quality of health-care in America and the world.

Furthermore, the present invention uniquely provides the only and fastest means for implementing said solution, and the most cost-effective, optimally and only-effective and realistic means for solving said crisis and, therefore, the objectives of the present invention are to fulfill the destiny of the American health-care system in the present century and beyond.

### SUMMARY OF THE INVENTION

The present invention uniquely provides the only and fastest means for implementing said solution, and the most cost-effective, optimally and only-effective and realistic means for solving American health-care crisis.

The present invention as a continuation-in-part of said application further expands a computerized system of computer-automated creation, expansion, management and propagation of health and health-care information of a person, individuals and/or people—patients. A computerized system comprising computer commands, health and health-care information and fields of distinct health and health-care information identifications adaptable to computer-automatically and continually merge health and health-care information on an individual, individuals or people to modify and expand on health and health-care databases on individual, individuals or people in a network of computers. Therefore, from the starting point of the system at which a physician's voice is transmitted to a digital voice recorder until said information are viewed as digital text information by any person or persons involved, the system computer-automatically and independently create, assimilate, merge, expand, manage and propagate said health and health-care information.

### DESCRIPTION OF THE PREFERRED EMBODIMENTS

Said pending application Ser. No. 11/114,763 taught a computerized system for influencing the health-care utilizations through the use of a plurality of templates on health and health-care related information created by conversion of digital audio information into digital text information comprising said information originated from physicians' audio outputs of said information into digital voice recorders.

Said pending application further taught a means for placing said digital text data into said templates and a process of placing digital text data into said templates. Specifically, as written in said pending application—“The computer-automated additions or insertions of specific portions of said digital text data into appropriate and corresponding appropriate portions in said templates are achieved by processes and means described herein.”

The present invention as a continuation-in-part of said application further expands a computerized system of computer-automated creation, expansion, management and propagation of health and health-care information of a person, individuals and/or people—patients. In other words, according to inventions supra, from the starting point of the system at which a physician's voice comprising “perfect” health and health-care information or data on a patient or patients is transmitted to a digital voice recorder to the point at which said information are viewed by any person or persons—patients and physicians—involved, the system computer-automatically and independently create, assimilate, merge, expand, manage and propagate said health and health-care information to optimally serve said patients and physicians.

The present invention provides the use of computer command means for computer-automatically and continually assimilating second health information and second health-care information on an individual, individuals or people into an optimal, appropriate and specific location or locations in first health information and first health-care information on said individual, individuals or people in a memory, memories or caches of a computer and memories or caches of a network of computers.

Said computer command means for assimilating said second health information and second health-care information when said second information are presented to said first health information and first health-care information are computer-automatically assigned to logistic computer a location, locations, a page, pages, a file, files or any combination thereof in said first information to achieve said results by yet another set of computer command means for assigning said computer command means for assimilating—the preferred. Said assignments of said computer command means occur at the onset of the creation of said first information so that the computer-automatic processes described herein computer-automatically and computer-perpetually propagated and expanded in said information memories or caches applicable to said individual, individuals and people.

Alternatively, the least desirable—said yet another set of computer command means can be manually assigned to achieve said effect by human labor which is tedious and plagues with errors and delays.

An identification means for identifying said second information is a means for permitting said computer command means to computer-automatically and continually assimilating said second health information and second health-care information into an optimal and specific location or locations in first health information and first health-care information on said individual, individuals or people.

For example, according to the description supra, said first health information comprising an identification means for identifying a specific location in said first information on an individual comprises:

<A physician's first and last names, date of birth, social security number>

<A patient's first and last names, date of birth and social security number>

<Patient's drug allergy+data1>

<Patient's food allergy+data2>

<Patient's past medical history+data3>

<Patient's past surgical history+data4>

<Patient's chief complaint+data5>

<Patient's diagnosis+data6>

<Treatment+data7>

<Procedures+data8>

<Follow-up+data9>

According to the claims of the present invention and the description supra, C1-C9 infra in said first information representing nine computer command means for assimilating second information into a specific location or computer field in said first information as follows:

<A physician's first and last names, date of birth, social security number>

<A patient's first and last names, date of birth and social security number>

C1<Patient's drug allergy+data1>

C2<Patient's food allergy+data2>

C3<Patient's past medical history+data3>

C4<Patient's past surgical history+data4>

C5<Patient's chief complaint+data5>

C6<Patient's diagnosis+data6>

C7<Treatment+data7>

C8<Procedures+data8>

C9<Follow-up+data9>

According to the claims of the present invention, subsequently, second health information comprise two distinct identification means for identifying said two second information as

<Patient's food allergy+data10>

<Patient's chief complaint+data11>

are presented to the above first information in said computer environment after said second information were output by physician or physicians through the digital audio data conversion into digital text data. The outcome according to the claims of the present invention is the assimilation or addition of said second health information into two optimal and specific locations in said first information as follows:

<A physician's first and last names, date of birth, social security number>

<A patient's first and last names, date of birth and social security number>

C1<Patient's drug allergy+data1>

C2<Patient's food allergy+data2+data10>

C3<Patient's past medical history+data3>

C4<Patient's past surgical history+data4>

C5<Patient's chief complaint+data5+data11>

C6<Patient's diagnosis+data6>

C7<Treatment+data7>

C8<Procedures+data8>

C9<Follow-up+data9>

Information on time, days, dates, months and years is also used and included where it serves to achieve the objectives and within the scope of the claims of the present invention.

Furthermore, according to the claims of the present invention, C1-C9 merely representing nine computer command means for assimilating said second information into other specific locations in said first information in other locations or files in said computers. According to the claims of the present invention, the permutations based on the simple examples supra on health and health-care information on an individual are infinite to create, expand and manage all health and health-care information on an individual. Similarly, said system extends to the creation, expansion and management of all health and health-care information on individuals or people within the scope of the claims of the present invention.

The execution of all permutations in said computerized system for automatically modifying, appending or adding to first health information and first health-care information on an individual, a plurality of individuals or people in a memory, memories or caches of a computer and memories or caches of a network of computers wherein second health information and health-care information on said individual, individuals or people derived from the conversions of digital audio data to digital text data comprising said second health information and health-care information are automatically added or appended to a specific location or a plurality of specific locations in said first information.

Said identification means for identifying a specific location or locations in said first information comprises a plurality of computer fields each of which comprising a word, words, a number, numbers or any combination thereof. The number includes or numbers include time, date, month and year.

In summary, the present invention provides a computerized system of health and health-care creation, expansion and management comprising similar or distinct—to fulfill the objective and scope of the claims of the present invention—computer command means for computer-automatically and continually assimilating or adding more health and health-care information—second health information and second health-care information—on an individual, individuals or people into any and all optimal and specific locations in first health information and first health-care information on said individual, individuals or people in a memory, memories or caches of a computer and memories or caches of a network of computers. Said computer command means permit accurate, precise and repetitive additions of said second information into any and all optimal and specific locations in said first information. Moreover, said system utilizes uniquely distinct identities on second health and health-care information comprising computer fields to achieve its objectives. Said first and second information are created or generated by a physician's and physicians' said-information outputs which are computer-automatically transformed into digital audio information and digital text information. Through said system and collaborations of computer commands and said features of said information, the objectives of the present invention are fulfilled.

Although the preferred embodiments of this invention have been described, it will be appreciated by those skilled in the art that adaptations and variations may be made without departing from the spirit of the invention and the scope of the claims.

1. A computerized system for automatically modifying first health information and first health-care information on an individual, a plurality of individuals or people in a memory, memories or caches of a computer and memories or caches of a network of computers wherein second health information and health-care information on said individual, individuals or people derived from the conversions of digital audio data to digital text data comprising said second health information and health-care information are automatically added or appended to a specific location or a plurality of specific locations in said first information comprises:
said first health information on an individual;
said first health information on individuals;
said first health information on people;
said first health-care information on an individual;
said first health-care information on individuals;
said first health-care information on people;
said second health-care information on said people;
an identification means for identifying a specific location in said first information;
an identification means for identifying a plurality of specific locations in said first information;
an identification means for identifying said second information;
a computer command means for assimilating said second information into a specific location in said first information;
a computer command means for assimilating said second information into a plurality of specific locations in said first information;
a process of assigning said computer command means for assimilating said second information into a specific location in said first information to said first information;
a process of assigning said computer command means for assimilating said second information into a plurality of specific locations in said first information to said first information;
a computer command means for assigning said computer command means for assimilating said second information into a specific location in said first information to said first information;
a computer command means for assigning said computer command means for assimilating said second information into a plurality of specific locations in said first information to said first information;
a process of assigning said computer command means for assigning said computer command means for assimilating said second information into a specific location in said first information to said first information;
a process of assigning said computer command means for assigning said computer command means for assimilating said second information into a plurality of specific
locations in said first information to said first information;
a computer command means for collaborating said identification means for identifying said second information and said computer command means for assimilating said second information into a specific location in said first information
a computer command means for collaborating said identification means for identifying said second information and said computer command means for assimilating said second information into a plurality of specific locations in said first information
a computerized process of collaborating the function of said computer command means for assimilating said second information into a specific location in said first information and the function of said identification means for identifying said second information; and
a computerized process of collaborating the function of said computer command means for assimilating said second information into a plurality of specific locations in said first information and the function of said identification means for identifying said second information.

2. The computerized system according to claim 1 wherein said identification means for identifying a specific location in said first information comprises a plurality of computer fields each of which comprising a word, words, a number, numbers or any combination thereof.

3. The computerized system according to claim 1 wherein said identification means for identifying a plurality of specific locations in said first information comprises a plurality of computer fields each of which comprising a word, words, a number, numbers or any combination thereof.

4. The computerized system according to claim 1 wherein said identification means for identifying a specific location in said first information comprises a computer field comprising at least a date, month and year.

5. The computerized system according to claim 1 wherein said identification means for identifying a plurality of specific locations in said first information comprises a computer field comprising at least a date, month and year.

6. The computerized system according to claim 1 wherein said identification means for identifying said second information comprises a computer field comprising at least a date, month and year and a word.

7. The computerized system according to claim 1 wherein said identification means for identifying said second information comprises a computer field comprising at least a date, month and year and a plurality of words.

8. The computerized system according to claim 1 wherein said computer command means for collaborating said identification means for identifying said second information and said computer command means for assimilating said second information into a specific location in said first information comprises computer command means for computer-automatically assimilating, adding or appending said second information into a specific location in said first information.

9. The computerized system according to claim 1 wherein said computer command means for collaborating said identification means for identifying said second information and said computer command means for assimilating said second information into a plurality of specific locations in said first information comprises computer command means for computer-automatically assimilating, adding or appending said second information into a plurality of specific locations in said first information.

10. A computer-automated system of continually modifying first health information and first health-care information on an individual, individuals or people in a memory, memories or caches of a computer and memories or caches of a network of computers wherein second health information and second health-care information on said individual, individuals or people generated by a physician's and physicians' said-information outputs computer-automatically transformed into digital audio information and digital text information are computer-automatically and appropriately added or appended to an optimal location or locations in said first information comprises:
said first health information on an individual;
said first health information on individuals;
said first health information on people;
said first health-care information on an individual;
said first health-care information on individuals;
said first health-care information on people;
said second health-care information on said people;
an identification means for identifying a specific location in said first information;
an identification means for identifying a plurality of specific locations in said first information;
an identification means for identifying said second information;
a computer command means for assimilating said second information into a specific location in said first information;
a computer command means for assimilating said second information into a plurality of specific locations in said first information;
a process of assigning said computer command means for assimilating said second information into a specific location in said first information to said first information;
a process of assigning said computer command means for assimilating said second information into a plurality of specific locations in said first information to said first information;
a computer command means for collaborating said identification means for identifying said second information and said computer command means for assimilating said second information into a specific location in said first information
a computer command means for collaborating said identification means for identifying said second information and said computer command means for assimilating said second information into a plurality of specific locations in said first information
a computerized process of collaborating the function of said computer command means for assimilating said second information into a specific location in said first information and the function of said identification means for identifying said second information; and
a computerized process of collaborating the function of said computer command means for assimilating said second information into a plurality of specific locations in said first information and the function of said identification means for identifying said second information.

11. A computerized system comprising, first, computer command means for computer-automatically and continually assimilating second health information and second health-care information on an individual, individuals or people generated by a physician's and physicians' said-information outputs computer-automatically transformed into digital audio information and digital text information into an optimal location or locations in first health information and first health-care information on said individual, individuals or people in a memory, memories or caches of a computer and memories or caches of a network of computers and, second, said second health and health-care information comprising computer fields wherein said computer command means and said computer fields collaborate to computer-automatically expand said first health information and health-care information comprises:
said first health information on an individual;
said first health information on individuals;
said first health information on people;
said first health-care information on an individual;
said first health-care information on individuals;
said first health-care information on people;
an identification means for identifying a specific location in said first information;
an identification means for identifying a plurality of specific locations in said first information;
an identification means for identifying said second information;
a computer command means for assimilating said second information into a specific location in said first information;
a computer command means for assimilating said second information into a plurality of specific locations in said first information;
a process of assigning said computer command means for assimilating said second information into a specific location in said first information to said first information;
a process of assigning said computer command means for assimilating said second information into a plurality of specific locations in said first information to said first information;
a computer command means for collaborating said identification means for identifying said second information and said computer command means for assimilating said second information into a specific location in said first information
a computer command means for collaborating said identification means for identifying said second information and said computer command means for assimilating said second information into a plurality of specific locations in said first information
a computerized process of collaborating the function of said computer command means for assimilating said second information into a specific location in said first information and the function of said identification means for identifying said second information; and
a computerized process of collaborating the function of said computer command means for assimilating said second information into a plurality of specific locations in said first information and the function of said identification means for identifying said second information.
